(19) United States
(12) Patent Application Publication
(10) Pub. No.: US 2008/0190954 A1
(43) Pub. Date: Aug. 14, 2008

(54) PERSONAL HYGIENIC WIPE

(76) Inventor: Michelle J. Kooyman, Cardiff by the Sea, CA (US)

Correspondence Address: MANUEL F. DE LA CERRA, 6885 CATAMARAN DRIVE, CARLSBAD, CA, 92011, US

(21) Appl. No.: 11/672,618

(22) Filed: Feb. 8, 2007

(51) Int. Cl. A01N 25/34; B65H 3/00

(52) U.S. Cl. 221/22; 424/404

(57) ABSTRACT

A novel pre-moistened personal hygienic wipe configured with one or more pockets and constructed entirely or partially of stretchable material is disclosed. The personal hygienic wipe may include a cuff fold for easy application and/or removal, and may be quilted material for enhanced cleaning capability. The wipe may also be disposable and biodegradable. Also provided is a novel pop-up dispenser for convenient dispensing of the personal hygienic wipe.

### 1. FIELD OF THE INVENTION

The present invention relates generally to a pre-moistened wipe for human personal hygiene.

### 2. BACKGROUND OF THE INVENTION

Consumers seeking a cleaning aid have a number of commercially available options to choose from, depending on the task at hand. For example, the market currently offers reusable, heavy-duty gloves to wash cars, electrostatically-charged cloths to dust furniture, and pre-moistened disposable washcloths to clean a baby's sensitive skin. Consumers consider ease of use, cost, and effectiveness in choosing an appropriate cleaning aid.

In the area of personal hygiene and cleanliness, several cleaning aids dominate consumer choice because of their low cost and versatility. Specifically, consumers typically reach for toilet paper, facial tissues, and pre-moistened baby wipes to meet personal hygiene needs. These all-purpose products are designed for effortless use by the average consumer, being dimensioned to protect the average-sized hand from the substance or matter to be cleaned. But not all hands are alike, nor do all consumers seek personal hygiene products with the same purpose or need in mind. For example, those with physical disabilities or diminished hand dexterity may find themselves unable to use these universal cleaning aids effectively, or to manipulate them at all.

One particular shortcoming of many personal hygiene cleaning aids on the market is their dispensing mechanisms. The typical toilet paper holder does not have a restricting mechanism to prevent the entire roll from being unraveled, and two hands (of unimpaired dexterity) are needed to tear a piece from the roll. Baby wipes also required unimpaired dexterity to locate the end of a single baby wipe in the compact brick in which wipes are sold and to pinch one wipe to separate it from the others in the brick.

Even after these personal hygiene products are dispensed, grasping, holding, and manipulating these products present more difficulties. As pliable sheets with no natural anchor points, toilet paper, facial tissue and baby wipes require both a constant grip to stay in contact with the hand and manual dexterity to wipe a surface clean. For example, the user's hand must apply an even, yet adjustable, pressure to keep the cleaning aid from slipping out of the hand entirely or bunching up on the changing contours of the body surface, thereby significantly reducing its effectiveness. Without these required fine motor skills, a user may not be able to use the cleaning product effectively and may even exacerbate the cleaning task to be accomplished.

Finally, personal hygiene products currently on the market are also limited in their ability to clean quickly and easily. Some products such as baby wipes are pre-moistened with a hygienic cleaning solution, but toilet paper and facial tissue are not. While the average consumer may not need a cleaning aid that is wet upon dispensing, consumers with physical impairments consider such a feature advantageous. When the dispensed personal hygiene product is already impregnated with a mild cleaning solution, the coordination, strength, and time required to clean the body surface may be reduced.

In sum, current personal hygiene products lack the anchor points to maintain the product in contact with the hand, dispensing mechanisms, and pre-moistened material that appeal to all consumers. These attributes may be merely convenient and useful or, with consumers with impaired dexterity, an absolute necessity.

### 3. SUMMARY OF THE INVENTION

The following specification provides a novel pre-moistened personal hygienic wipe configured with one or more pockets and constructed entirely or partially of stretchable material. The wipe may include additional advantageous features, including a cuff fold for easy application and/or removal, and quilted material for enhanced cleaning capability. It also may be advantageous that the personal hygienic wipe be disposable, either in a conventional waste container or by flushing in a toilet.

In another embodiment, the personal hygienic device is contained in a convenient pop-up dispenser that comprises a container that contains a plurality of disposable personal hygienic wipes, wherein the container further comprises an opening through which the plurality of personal hygienic wipes may be accessed and an opening cover. The plurality of personal hygienic wipes are configured in the dispenser container such that that pulling one wipe out of the container through the opening causes the next wipe in the plurality to pop-up through the opening for ready access.

### 4. BRIEF DESCRIPTION OF THE DRAWINGS

Features, aspects, and embodiments of the novel personal hygienic wipe are described in conjunction with the attached drawings, in which:

FIG. 1 is a perspective view of an embodiment of the novel pre-moistened personal hygienic wipe which contains a single pocket.

FIG. 2 is a perspective view of an improvement that includes a cuff to the novel pre-moistened personal hygienic wipe.

FIG. 3 is a perspective view of a dispenser for the novel pre-moistened wipe.

FIG. 4 is a perspective view of an embodiment of the novel pre-moistened personal hygienic wipe which contains two pockets.

FIG. 5 is a perspective view of an embodiment of the novel pre-moistened personal hygienic wipe which contains five pockets.

### 5. DETAILED DESCRIPTION

To overcome the limitations of hygienic cleaning products currently available on the market, a personal hygienic wipe is provided for the average consumer as well as those with special needs. FIG. 1 illustrates a personal hygienic wipe (010) that contains a single pocket (012). The user slips his or her hand (020) into the pocket opening (014), so that the user's hand (020) is encased in the single pocket (012). The user is now protected and can begin their personal hygiene.

The single pocket (012) is dimensioned to fit securely around the hand (020). Once the hand (020) is placed inside the single pocket (012), the personal hygienic wipe maintains a secure position on the user's hand with little to no readjustment throughout the cleaning task, unlike the single sheet wipe provided by the prior art.

The material from which the pocket (012) is constructed further enhances this anchoring characteristic and the stability of the pocket (012) on the hand. In one embodiment, substantially all of the pocket (012) is constructed of stretchable material such that it flexes around the hand (020) as the user wipes the surface to be cleaned. This stretchable material allows the pocket (012) to be dimensioned to fit closely around the user's hand (020), and still maintain its structural integrity when subjected to the stretching and flexing of hand (020) inside the pocket (012). The elasticity of the stretchable material ensures that when a user pulls the pocket over his or her hand, the pocket (012) stays on the hand with minimal interaction or readjustment. This effort-conserving feature is especially advantageous for users who are restricted in their movement or manual dexterity, and are unable to use a cleaning aid that requires constant exertion to perform repeated readjustments. Finally, the stretchable material allows pocket (012) to accommodate hands of various sizes, further enhancing the utility of the wipe.

In another embodiment, the pocket (012) can be constructed primarily of non-stretchable material, with a horizontal band of stretchable material (018) located across the pocket (012). This band of stretchable material (018) is positioned to allow the pocket (010) to flex and expand when, for example, the palm (022) of user's hand (020) bends inside the pocket (012). Accommodating the changing dimensions of the hand (020) ensures the pocket (010) does not tear or rip when the palm (022) bends or the hand (020) closes into a fist. The band of stretchable material may also be positioned at or near the pocket opening (014), which would help cinch the pocket (012) on the user's hand. The band of stretchable material may also be positioned across the area of the pocket (010) that covers the knuckles of the user's hand.

The personal hygienic wipe (010) is pre-moistened with a hygienic cleaning solution, further enhancing its ability to clean body surfaces hygienically and easily. First, the user does not have to take the additional step of applying a soap or other cleaning solution to personal hygienic wipe (010) before using it. Second, cleaning the body surface requires fewer wiping motions and less time if the cleaning surface is already wet when it is dispensed. Less force, manual dexterity, and effort is required to accomplish the same cleaning task as would be required with a dry cleaning surface. This step-saving feature is particularly useful for those users who lack the manual dexterity or motor skills to, for example, turn a faucet handle in order to moisten a dry wipe.

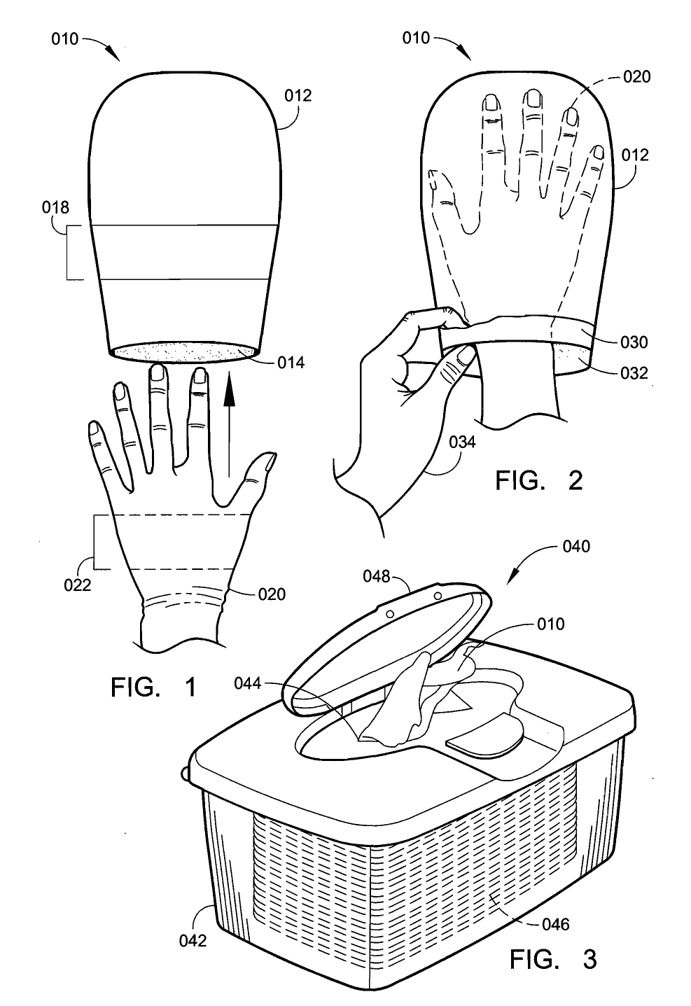

Although the personal hygienic wipe (010) is effective and easy to use in the configuration just described with regards to FIG. 1, additional features enhance the accessibility and convenience of the personal hygienic wipe (010). FIG. 2 illustrates one such improvement: a cuff fold (030) located on the cuff (032) of the pocket (012). The cuff fold may be used for at least two functions: applying the personal hygienic wipe and removing the personal hygienic wipe.

The user may hold on to the cuff fold (030) with his free hand (034)—i.e., the hand that is not being inserted into the pocket (012)—which provides an anchor for the wipe allowing hand 020 to slide in a more smooth and controlled motion into the pocket (012). After the hand (020) has been inserted into the pocket (012) and the cleaning task performed, cuff fold (030) allows the user to use his or her free hand (034) to effortlessly remove the personal hygienic device (010) from the hand (020). Specifically, the cuff fold (030) is positioned on the personal hygienic device (010) to be readily accessible and easily grasped by the free hand (034), obviating the need to fumble about for an anchor point on which to grab on. Once the free hand (034) has located and grasped the cuff fold (030), the free hand (034) can pull pocket (010) away from the hand (020) in one smooth motion. In performing this pulling motion, the user may simply back the hand (020) out of the pocket (012), or the user may turn the pocket (012) inside-out in the process and trap any soiled, and possibly unhygienic, surfaces inside the inverted pocket (012). Thus, the cuff fold (030) not only facilitates the effortless removal of the pocket (010) from the hand (020), but it helps ensure neither hand 020 nor free hand 034 are soiled in the process of removing the pocket (012) from hand 020.

Referring now to FIG. 3, a pop-up dispenser (040) for use in dispensing the personal hygienic wipe (010) is shown. The dispenser (040) includes a container (042) with an opening (044) suitable for storing a plurality of personal hygienic wipes (046). The dispenser (040) is further constructed to prevent the plurality of personal hygienic wipes (046) from drying out. The personal hygienic wipes may be folded and stacked one on top of another in such a way that pulling one wipe up out of the dispenser (040) causes the next personal hygienic wipe to pop-up through the opening (044), ready and accessible to be pulled up out of the dispenser (040). In another embodiment, the personal hygienic wipes may be constructed such that each personal hygienic wipe detachably connects to the next personal hygienic wipe. This connection may be through a mild adhesive or by a perforated structure. When a user pulls one personal hygienic wipe, this action may causes the next wipe to pop-up through the opening (044) and causes the detachable connection to sever. In the perforated structure embodiment, the user may have to specifically sever the detachable connection.

This convenient dispensing mechanism ensures one personal hygienic wipe is always partially dispensed through the opening (044) of the dispenser (040) at any given time, primed and ready for use at a moment's notice. An opening cover (048) may also be provided to seal the opening (044) and keep the personal hygienic wipes pre-moistened when the dispenser (040) is not in use. The opening cover (048) may be a separate piece from the container (042), but more preferably it would be integrated with the container (042) on a hinge mechanism such that it can swing closed and seal the container (042). The pop-up mechanism of this dispenser (040) has the additional advantage of helping those with physical disabilities access and use the wipe effortlessly.

Yet another improvement to the novel personal hygienic wipe described above is the use of a material that is quilted, or characterized by a regularly-spaced raised pattern. This quilted material has superior cleaning properties over a smooth, non-ridged material, because the ridges in the quilted material provide a rougher, more abrasive cleaning surface. This improved cleaning capacity does not sacrifice comfort in the use of the personal hygienic wipe, however, as the quilted material is still gentle enough for use on human skin.

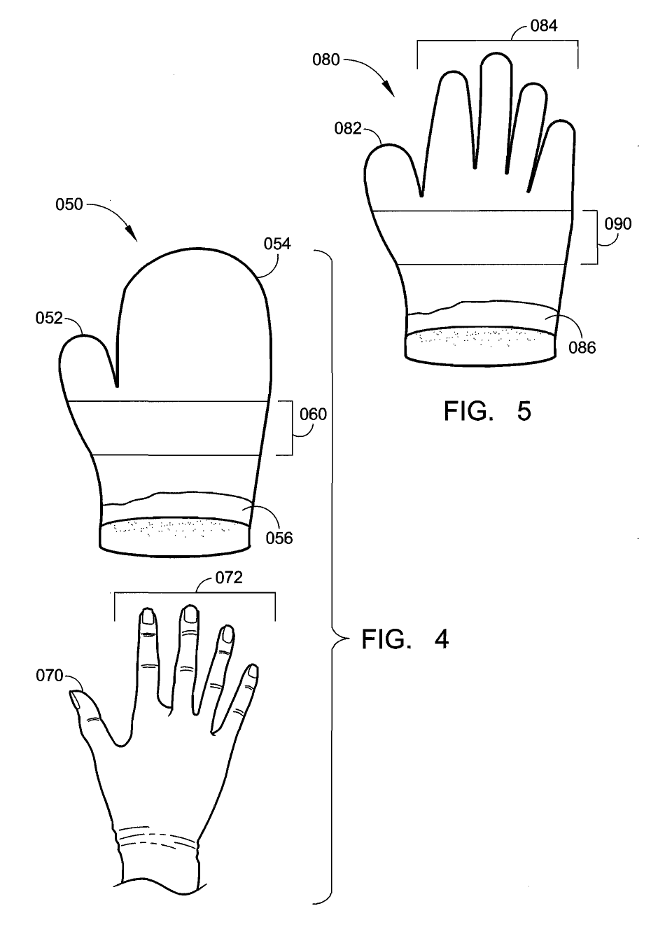

A person of ordinary skill in the art will understand the novel personal hygienic wipe is not limited to a wipe providing a single pocket to accommodate the user's hand. Thus, the personal hygienic wipe illustrated in FIG. 4 is an alternative embodiment. Like the single pocket configuration described above, this personal hygienic wipe (050) is pre-moistened and made of stretchable material. Additionally, the wipe (050) can be constructed primarily of non-stretchable material, with a band of stretchable material (060) located horizontally across the mitt (050). Unlike the single pocket configuration, however, this wipe is configured with two pockets in the general shape of a mitt. One thumb pocket (052) is positioned to accommodate the user's thumb (070), while the second, larger pocket (054) accommodates the remaining fingers (072) of the user's hand.

The distinct thumb pocket (052) of this embodiment enhances the stability and integrity of the mitt-shaped personal hygienic wipe (050) during use as a cleaning aid. Specifically, the user's thumb (070) inside the thumb pocket (052) acts as an additional anchor maintaining the mitt-shaped personal hygienic wipe (050) on the user's hand. The interaction between the user's thumb (070) and the thumb pocket (052) reduces the likelihood that the mitt-shaped personal hygienic wipe (050) will slip out of the user's hand and gives the user more control during the cleaning task. Further, even if the user does not have the use of his or her thumb, the distinct thumb pocket (052) still acts as an anchor maintaining the mitt-shaped personal hygienic wipe (050) on the user's hand. This additional anchoring and stability feature is particularly useful to disabled users who lack the dexterity or fine motor grasp of the average consumer.

The two-pocket personal hygienic wipe can also be improved with the same performance-enhancing features as the single-pocket personal hygienic wipe. Namely, the two-pocket personal hygienic wipe can be equipped with a cuff fold (056), constructed of quilted material, or dispensed from a pop-up assembly as illustrated in FIG. 3.

The novel personal hygienic wipe is not limited to one or two pocket configurations; rather the inventive features and improvements described above can also be applied to personal hygienic wipes of different shapes and sizes. For example, FIG. 5 illustrates an embodiment containing more than two finger pockets. Configured in the general shape of a glove, a personal hygienic wipe (080) includes a distinct thumb pocket (082) and additional finger pockets (084) to accommodate the remaining fingers of the user's hand. The four additional finger pockets (084) in FIG. 5 are for illustrative purposes only, and do not limit the shape or number of additional finger pockets. Like the embodiments described above, the glove-shaped personal hygienic wipe (080) is pre-moistened. Moreover, the glove-shaped personal hygienic wipe (080) can be constructed primarily of non-stretchable material, with a horizontal band of stretchable material (090) located horizontally across the glove-shaped personal hygienic wipe (080). Alternatively, the wipe (080) may be constructed substantially of stretchable material. It may also be equipped with a cuff fold 086, dispensed from a pop-up assembly as illustrated in FIG. 3, constructed of quilted material, or offer some combination of these three features.

In all embodiments, the personal hygienic wipe is disposable, such that it can be disposed of in a conventional waste container or by flushing in a toilet. The wipe may be for a single-use such that after the single use it can be disposed of in a waste container or a toilet. In its flushable configuration, the wipe can be dimensioned to meet disposal requirements of conventional toilets and constructed of a flushable material that will not clog sanitary systems. In an alternative flushable configuration, the wipe can be constructed of biodegradable material to ensure the personal hygienic wipe is safe for use in recreational vehicle, campground, military latrine, and other sensitive sanitary systems.

Having described the methods and structures in detail and by reference to several preferred embodiments thereof, it will be apparent that modifications and variations are possible without departing from the scope of the invention defined in the following claims. Moreover, the applicants expressly do not intend that the following claims “and the embodiments in the specification to be strictly coextensive.” Phillips v. AHW Corp., 415 F.3d 1303, 1323 (Fed. Cir. 2005) (en banc).

1. A disposable personal hygienic wipe, comprising:
at least one pocket, wherein the pocket further comprises a pocket opening and wherein the pocket is constructed to receive the hand of a user through the pocket opening; and
wherein the wipe is pre-moistened with a cleaning solution and constructed at least partially of stretchable material.

2. The personal hygienic wipe of claim 1, further comprising a cuff fold adapted to assist the user in the application or removal of the wipe from the hand.

3. The personal hygienic wipe of claim 1, wherein the wipe is constructed at least partially of quilted material.

4. The personal hygienic wipe of claim 1, wherein the wipe is biodegradable.

5. The personal hygienic wipe of claim 1, wherein the stretchable material is localized as a band across the at least one pocket.

6. The personal hygienic wipe of claim 5, wherein the band covers the knuckles of the user's hand.

7. The personal hygienic wipe of claim 1, wherein the at least one pocket further comprises two pockets wherein one of the pockets is a thumb pocket.

8. The personal hygienic wipe of claim 1, wherein the at least one pocket further comprises five pockets, wherein each pocket is adapted to receive a different digit from the user's hand.

9. The personal hygienic wipe of claim 1, wherein the personal hygienic wipe is a single-use wipe.

10. A disposable personal hygienic wipe, comprising:
a mitt with two pockets, wherein one pocket is constructed to receive the thumb of the hand of a user and wherein the mitt is pre-moistened with a cleaning solution and is at least partially quilted;
the mitt further comprises:
a band that is constructed of stretchable material; and
a cuff fold adapted to assist the user in the application or removal of the mitt from the hand.

11. The personal hygienic wipe of claim 5, wherein the band covers the knuckles of the user's hand.

12. The personal hygienic wipe of claim 10, wherein the personal hygienic wipe is a single-use wipe.

13. A dispenser for a disposable personal hygienic wipe, comprising:
a container that contains a plurality of disposable personal hygienic wipes, each individual wipe of the plurality comprises:
at least one pocket, wherein the pocket further comprises a pocket opening and wherein the pocket is constructed to receive the hand of a user through the pocket opening; and
wherein the wipe is pre-moistened with a cleaning solution and constructed at least partially of stretchable material;
the container further comprises:
an opening through which the plurality of personal hygienic wipes may be accessed;
and an opening cover;
the plurality of personal hygienic wipes are configured such that that pulling one wipe out of the container through the opening causes the next wipe in said plurality to pop-up through the opening for ready access.

14. The dispenser of claim 13, wherein each individual wipe further comprises a cuff fold adapted to assist the user in the application or removal of the wipe from the hand.

15. The dispenser of claim 13, wherein each individual wipe is constructed at least partially of quilted material.

16. The dispenser of claim 13, wherein each individual wipe is biodegradable.

17. The dispenser of claim 13, wherein the stretchable material is localized as a band across the at least one pocket.

18. The dispenser of claim 17, wherein the band covers the knuckles of the user's hand.

19. The dispenser of claim 13, wherein the at least one pocket further comprises two pockets wherein one of the pockets is a thumb pocket.

20. The dispenser of claim 13, wherein the at least one pocket further comprises five pockets, wherein each pocket is adapted to receive a different digit from the user's hand.

21. The dispenser of claim 13, wherein each individual wipe is a single-use wipe.
